(19) United States
(12) Patent Application Publication
(10) Pub. No.: US 2022/0270604 A1
(43) Pub. Date: Aug. 25, 2022

(54) ELECTRONIC DEVICE AND OPERATION METHOD THEREOF

(71) Applicant: Samsung Electronics Co., Ltd., Suwon-si (KR)

(72) Inventors: Yoonju LEE, Suwon-si (KR); Yoonjae PARK, Suwon-si (KR)

(21) Appl. No.: 17/668,878

(22) Filed: Feb. 10, 2022

Related U.S. Application Data
(63) Continuation of application No. PCT/KR2022/001959, filed on Feb. 9, 2022.

(30) Foreign Application Priority Data
Feb. 19, 2021 (KR) 10-2021-0022745

(51) Int. Cl. G10L 15/22; G10L 15/30; G10L 15/16; G10L 15/02; G10L 15/18

(52) U.S. Cl. CPC G10L 15/22; G10L 15/30; G10L 15/16; G10L 15/02; G10L 15/18; G10L 2015/223

(57) ABSTRACT

An electronic device is provided. The electronic device includes a processor and a memory operatively connected to the processor. The memory may store instructions that, when executed, cause the processor to extract at least one or more utterance records of a user by using a user account included in the electronic device or operatively connected to the electronic device, to analyze the extracted at least one or more utterance records, to generate an utterance set including at least one or more operations based on the analyzed utterance records, to generate at least one or more quick command names corresponding to the utterance set, and to provide response data including the at least one or more quick command names.

### CROSS-REFERENCE TO RELATED APPLICATION(S)

This application is a continuation application, claiming priority under § 365(c), of an International application No. PCT/KR2022/001959, filed on Feb. 9, 2022, which is based on and claims the benefit of a Korean patent application number 10-2021-0022745, filed on Feb. 19, 2021, in the Korean Intellectual Property Office, the disclosure of which is incorporated by reference herein in its entirety.

### BACKGROUND

### 1. Field

The disclosure relates to an electronic device and an operating method thereof.

### 2. Description of Related Art

Nowadays, with the development of artificial intelligence (AI) technology, terminals including AI used for the main purpose of assistant are spread. Furthermore, in addition to a conventional input method using a keyboard or a mouse, electronic devices have recently supported various input methods such as a voice input. For example, the electronic devices such as smart phones or tablet personal computers (PCs) may receive a user voice and then may provide a service that performs an operation corresponding to the received user voice.

The speech recognition service is being developed based on a technology for processing a natural language. The technology for processing a natural language refers to a technology that grasps the intent of a user input (utterance) and generates the result matched with the intent to provide the user with the service.

In the meantime, the voice recognition service provides a quick command function that enables the electronic device to perform various functions based on a specific input of a user. Users naturally give various commands to the AI included in the terminal, or have a conversation with the AI.

Accordingly, there is an increasing need to recommend a quick command and/or a quick command name optimized for users.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and device for providing a personalized quick command and/or quick command name.

Another aspect of the disclosure is to provide a method and device for providing a quick command and/or quick command name generated based on user input.

Another aspect of the disclosure is to provide a method and device for providing a quick command and/or quick command name generated based on a usage pattern of a user.

Another aspect of the disclosure is to provide a method and device for providing the user with a consistent user experience by providing a quick command and/or quick command name based on the quick command, even when the user directly adds the quick command.

Additional aspects will be set forth in part in the description which follows and, in part, will be apparent from the description, or may be learned by practice of the presented embodiments.

In accordance with an aspect of the disclosure, an electronic device is provided. The electronic device includes a processor and a memory operatively connected to the processor. The memory may store instructions that, when executed, cause the processor to extract at least one or more utterance records of a user by using a user account included in the electronic device or operatively connected to the electronic device, to analyze the extracted at least one or more utterance records, to generate an utterance set including at least one or more operations based on the analyzed utterance records, to generate at least one or more quick command names corresponding to the utterance set, and to provide response data including the at least one or more quick command names.

In accordance with another aspect of the disclosure, a method performed by an electronic device is provided. The method includes extracting at least one or more utterance records of a user by using a user account included in the electronic device or operatively connected to the electronic device when a process for a memory included in the electronic device or operatively connected to the electronic device is executed, analyzing the extracted at least one or more utterance records, generating an utterance set including at least one or more operations based on the analyzed utterance records, generating at least one or more quick command names corresponding to the utterance set, and providing response data including the at least one or more quick command names.

According to embodiments disclosed in this specification, it is possible to provide a method and device for providing a quick command and/or quick command name generated based on a user's usage pattern.

According to embodiments disclosed in this specification, it is possible to provide a method and device for providing a quick command and/or quick command name generated based on a user input.

According to embodiments disclosed in this specification, it is possible to provide a method and device for providing a quick command and/or quick command name based on the quick command, even when a user directly adds the quick command.

Besides, a variety of effects directly or indirectly understood through the specification may be provided.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment, according to an embodiment of the disclosure;

FIG. 2 is a block diagram of a program, according to an embodiment of the disclosure;

FIG. 3 is a block diagram illustrating an integrated intelligence system, according to an embodiment of the disclosure;

FIG. 4 is a diagram illustrating a form in which relationship information between a concept and an action is stored in a database, according to an embodiment of the disclosure;

FIG. 5 is a view illustrating a user terminal displaying a screen of processing a voice input received through an intelligence app, according to an embodiment of the disclosure;

FIG. 6 is a block diagram illustrating a structure of an electronic device, according to an embodiment of the disclosure;

FIG. 7 is another block diagram illustrating a structure of an electronic device, according to an embodiment of the disclosure;

FIG. 8 is a diagram of a user's utterance record, according to an embodiment of the disclosure;

FIG. 9 is a diagram in which a conversation record of a user is converted into a sequence, according to an embodiment of the disclosure;

FIG. 10 is a diagram of an element table including a natural language (NL) result of an utterance generated by analyzing a user's utterance record, according to an embodiment of the disclosure;

FIG. 11 is a conceptual diagram of a method, in which an electronic device recommends a quick command name by using an important keyword, according to an embodiment of the disclosure;

FIG. 12 is a conceptual diagram illustrating a method, in which an electronic device recommends a quick command name by using information about utterance reception time and/or utterance reception place, according to an embodiment of the disclosure;

FIG. 13 is a conceptual diagram illustrating a method, in which an electronic device finds words and/or phrases having a high similarity with words, phrases and/or sentences included in an utterance set and generates and/or recommends the words and/or phrases as a quick command name, according to an embodiment of the disclosure;

FIG. 14 is a flowchart of a method, in which an electronic device recommends a quick command name, according to an embodiment of the disclosure; and

FIG. 15 is another flowchart of a method, in which an electronic device recommends a quick command name, according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

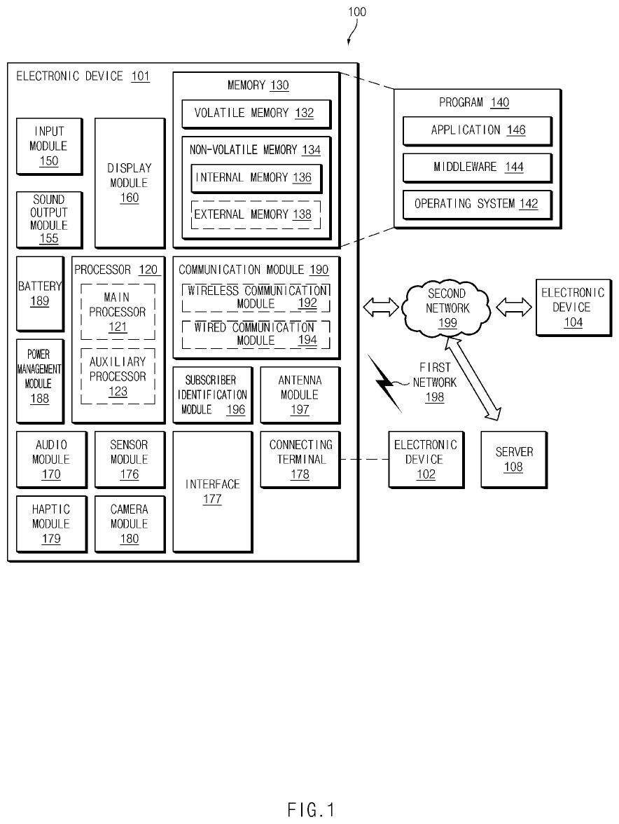

FIG. 1 is a block diagram illustrating an electronic device in a network environment according to an embodiment of the disclosure.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102 and 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

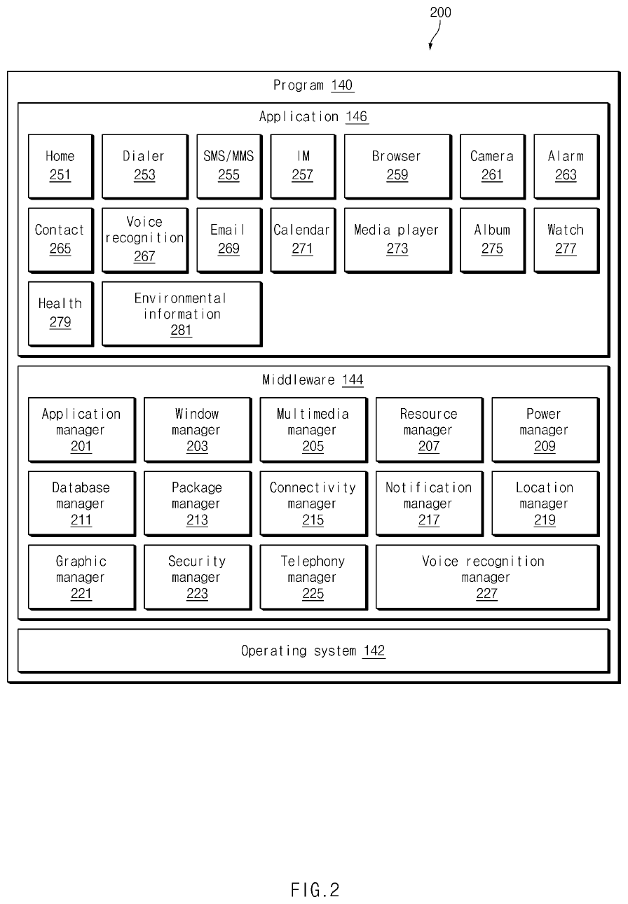

FIG. 2 is a block diagram 200 illustrating the program 140 according to an embodiment of the disclosure.

Referring to FIG. 2, the program 140 may include an operating system (OS) 142 to control one or more resources of the electronic device 101, middleware 144, or an application 146 executable in the OS 142. The OS 142 may include, for example, Android™, iOS™, Windows™, Symbian™, Tizen™, or Bada™. At least part of the program 140, for example, may be pre-loaded on the electronic device 101 during manufacture, or may be downloaded from or updated by an external electronic device (e.g., the electronic device 102 or 104, or the server 108) during use by a user.

The OS 142 may control management (e.g., allocating or deallocation) of one or more system resources (e.g., process, memory, or power source) of the electronic device 101. The OS 142, additionally or alternatively, may include one or more driver programs to drive other hardware devices of the electronic device 101, for example, the input module 150, the sound output module 155, the display module 160, the audio module 170, the sensor module 176, the interface 177, the haptic module 179, the camera module 180, the power management module 188, the battery 189, the communication module 190, the subscriber identification module 196, or the antenna module 197.

The middleware 144 may provide various functions to the application 146 such that a function or information provided from one or more resources of the electronic device 101 may be used by the application 146. The middleware 144 may include, for example, an application manager 201, a window manager 203, a multimedia manager 205, a resource manager 207, a power manager 209, a database manager 211, a package manager 213, a connectivity manager 215, a notification manager 217, a location manager 219, a graphic manager 221, a security manager 223, a telephony manager 225, or a voice recognition manager 227.

The application manager 201, for example, may manage the life cycle of the application 146. The window manager 203, for example, may manage one or more graphical user interface (GUI) resources that are used on a screen. The multimedia manager 205, for example, may identify one or more formats to be used to play media files, and may encode or decode a corresponding one of the media files using a codec appropriate for a corresponding format selected from the one or more formats. The resource manager 207, for example, may manage the source code of the application 146 or a memory space of the memory 130. The power manager 209, for example, may manage the capacity, temperature, or power of the battery 189, and determine or provide related information to be used for the operation of the electronic device 101 based at least in part on corresponding information of the capacity, temperature, or power of the battery 189. According to an embodiment, the power manager 209 may interwork with a basic input/output system (BIOS) (not shown) of the electronic device 101.

The database manager 211, for example, may generate, search, or change a database to be used by the application 146. The package manager 213, for example, may manage installation or update of an application that is distributed in the form of a package file. The connectivity manager 215, for example, may manage a wireless connection or a direct connection between the electronic device 101 and the external electronic device. The notification manager 217, for example, may provide a function to notify a user of an occurrence of a specified event (e.g., an incoming call, message, or alert). The location manager 219, for example, may manage locational information on the electronic device 101. The graphic manager 221, for example, may manage one or more graphic effects to be offered to a user or a user interface related to the one or more graphic effects.

The security manager 223, for example, may provide system security or user authentication. The telephony manager 225, for example, may manage a voice call function or a video call function provided by the electronic device 101. The voice recognition manager 227, for example, may transmit a user's voice data to the server 108, and receive, from the server 108, a command corresponding to a function to be executed on the electronic device 101 based at least in part on the voice data, or text data converted based at least in part on the voice data. According to an embodiment, the middleware 144 may dynamically delete some existing components or add new components. According to an embodiment, at least part of the middleware 144 may be included as part of the OS 142 or may be implemented as another software separate from the OS 142.

The application 146 may include, for example, a home 251, dialer 253, short message service (SMS)/multimedia messaging service (MIMS) 255, instant message (IM) 257, browser 259, camera 261, alarm 263, contact 265, voice recognition 267, email 269, calendar 271, media player 273, album 275, watch 277, health 279 (e.g., for measuring the degree of workout or biometric information, such as blood sugar), or environmental information 281 (e.g., for measuring air pressure, humidity, or temperature information) application. According to an embodiment, the application 146 may further include an information exchanging application (not shown) that is capable of supporting information exchange between the electronic device 101 and the external electronic device. The information exchange application, for example, may include a notification relay application adapted to transfer designated information (e.g., a call, message, or alert) to the external electronic device or a device management application adapted to manage the external electronic device. The notification relay application may transfer notification information corresponding to an occurrence of a specified event (e.g., receipt of an email) at another application (e.g., the email application 269) of the electronic device 101 to the external electronic device. Additionally or alternatively, the notification relay application may receive notification information from the external electronic device and provide the notification information to a user of the electronic device 101.

The device management application may control the power (e.g., turn-on or turn-off) or the function (e.g., adjustment of brightness, resolution, or focus) of the external electronic device or some component thereof (e.g., a display device or a camera module of the external electronic device). The device management application, additionally or alternatively, may support installation, delete, or update of an application running on the external electronic device.

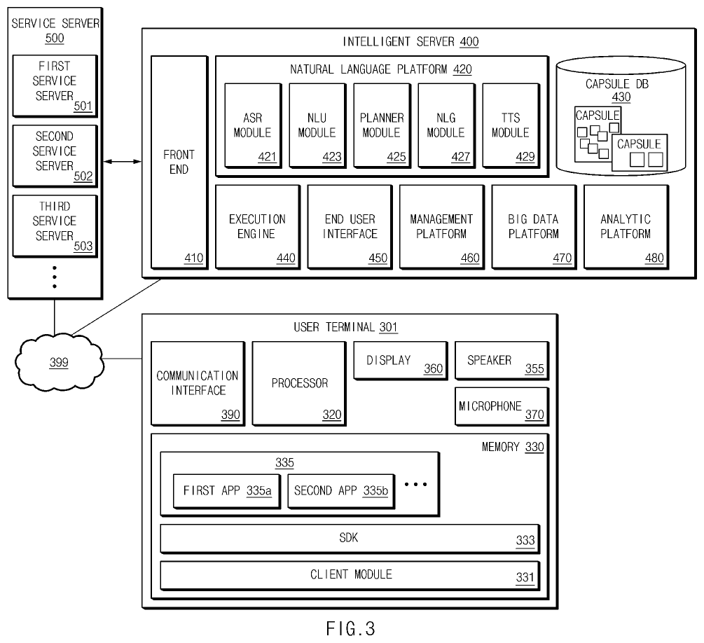

FIG. 3 is a block diagram illustrating an integrated intelligence system, according to an embodiment of the disclosure.

Referring to FIG. 3, an integrated intelligence system according to an embodiment may include a user terminal 301, an intelligence server 400, and a service server 500.

The user terminal 301 according to an embodiment may be a terminal device (or an electronic device) capable of connecting to Internet, and may be, for example, a mobile phone, a smartphone, a personal digital assistant (PDA), a notebook computer, a television (TV), a white household appliance, a wearable device, a head mounted display (HID), or a smart speaker.

According to the illustrated embodiment, the user terminal 301 may include a communication interface 390, a microphone 370, a speaker 355, a display 360, a memory 330, or a processor 320. The listed components may be operatively or electrically connected to one another.

The communication interface 390 according to an embodiment may be connected to an external device and may be configured to transmit or receive data to or from the external device. The microphone 370 according to an embodiment may receive a sound (e.g., a user utterance) to convert the sound into an electrical signal. The speaker 355 according to an embodiment may output the electrical signal as sound (e.g., voice). The display 360 according to an embodiment may be configured to display an image or a video. The display 360 according to an embodiment may display the graphical user interface (GUI) of the running app (or an application program).

The memory 330 according to an embodiment may store a client module 331, a software development kit (SDK) 333, and a plurality of apps 335. The client module 331 and the SDK 333 may constitute a framework (or a solution program) for performing general-purposed functions. Furthermore, the client module 331 or the SDK 333 may constitute the framework for processing a voice input.

The plurality of apps 335 may be programs for performing a specified function. According to an embodiment, the plurality of apps 335 may include a first app 335a and/or a second app 335b. According to an embodiment, each of the plurality of apps 335 may include a plurality of actions for performing a specified function. For example, the apps may include an alarm app, a message app, and/or a schedule app. According to an embodiment, the plurality of apps 335 may be executed by the processor 320 to sequentially execute at least part of the plurality of actions.

According to an embodiment, the processor 320 may control overall operations of the user terminal 301. For example, the processor 320 may be electrically connected to the communication interface 390, the microphone 370, the speaker 355, and the display 360 so as to perform a specified operation. For example, the processor 320 may include at least one processor.

Moreover, the processor 320 according to an embodiment may execute the program stored in the memory 330 so as to perform a specified function. For example, according to an embodiment, the processor 320 may execute at least one of the client module 331 or the SDK 333 so as to perform a following operation for processing a voice input. The processor 320 may control operations of the plurality of apps 335 via the SDK 333. The following actions described as the actions of the client module 331 or the SDK 333 may be the actions performed by the execution of the processor 320.

According to an embodiment, the client module 331 may receive a voice input. For example, the client module 331 may receive a voice signal corresponding to a user utterance detected through the microphone 370. The client module 331 may transmit the received voice input (e.g., a voice signal) to the intelligence server 400. The client module 331 may transmit state information of the user terminal 301 to the intelligence server 400 together with the received voice input. For example, the state information may be execution state information of an app.

According to an embodiment, the client module 331 may receive a result corresponding to the received voice input. For example, when the intelligence server 400 is capable of calculating the result corresponding to the received voice input, the client module 331 may receive the result corresponding to the received voice input. The client module 331 may display the received result on the display 360.

According to an embodiment, the client module 331 may receive a plan corresponding to the received voice input. The client module 331 may display, on the display 360, a result of executing a plurality of actions of an app depending on the plan. For example, the client module 331 may sequentially display the result of executing the plurality of actions on a display. For another example, the user terminal 301 may display only a part of results (e.g., a result of the last action) of executing the plurality of actions, on the display.

According to an embodiment, the client module 331 may receive a request for obtaining information necessary to calculate the result corresponding to a voice input, from the intelligence server 400. According to an embodiment, the client module 331 may transmit the necessary information to the intelligence server 400 in response to the request.

According to an embodiment, the client module 331 may transmit, to the intelligence server 400, information about the result of executing a plurality of actions depending on the plan. The intelligence server 400 may identify that the received voice input is correctly processed, using the result information.

According to an embodiment, the client module 331 may include a speech recognition module. According to an embodiment, the client module 331 may recognize a voice input for performing a limited function, via the speech recognition module. For example, the client module 331 may launch an intelligence app for processing a specific voice input by performing an organic action, in response to a specified voice input (e.g., wake up!).

According to an embodiment, the intelligence server 400 may receive information associated with a user's voice input from the user terminal 301 over a communication network. According to an embodiment, the intelligence server 400 may convert data associated with the received voice input to text data. According to an embodiment, the intelligence server 400 may generate at least one plan for performing a task corresponding to the user's voice input, based on the text data.

According to an embodiment, the plan may be generated by an artificial intelligent (AI) system. The AI system may be a rule-based system, or may be a neural network-based system (e.g., a feedforward neural network (FNN) and/or a recurrent neural network (RNN)). Alternatively, the AI system may be a combination of the above-described systems or an AI system different from the above-described system. According to an embodiment, the plan may be selected from a set of predefined plans or may be generated in real time in response to a user's request. For example, the AI system may select at least one plan of the plurality of predefined plans.

According to an embodiment, the intelligence server 400 may transmit a result according to the generated plan to the user terminal 301 or may transmit the generated plan to the user terminal 301. According to an embodiment, the user terminal 301 may display the result according to the plan, on a display. According to an embodiment, the user terminal 301 may display a result of executing the action according to the plan, on the display.

The intelligence server 400 according to an embodiment may include a front end 410, a natural language platform 420, a capsule database 430, an execution engine 440, an end user interface 450, a management platform 460, a big data platform 470, or an analytic platform 480.

According to an embodiment, the front end 410 may receive a voice input received from the user terminal 300. The front end 410 may transmit a response corresponding to the voice input to the user terminal 301.

According to an embodiment, the natural language platform 420 may include an automatic speech recognition (ASR) module 421, a natural language understanding (NLU) module 423, a planner module 425, a natural language generator (NLG) module 427, and/or a text to speech module (TTS) module 429.

According to an embodiment, the ASR module 421 may convert the voice input received from the user terminal 301 into text data. According to an embodiment, the NLU module 423 may grasp the intent of the user, using the text data of the voice input. For example, the NLU module 423 may grasp the intent of the user by performing syntactic analysis or semantic analysis. According to an embodiment, the NLU module 423 may grasp the meaning of words extracted from the voice input by using linguistic features (e.g., syntactic elements) such as morphemes or phrases and may determine the intent of the user by matching the grasped meaning of the words to the intent.

According to an embodiment, the planner module 425 may generate the plan by using a parameter and the intent that is determined by the NLU module 423. According to an embodiment, the planner module 425 may determine a plurality of domains necessary to perform a task, based on the determined intent. The planner module 425 may determine a plurality of actions included in each of the plurality of domains determined based on the intent. According to an embodiment, the planner module 425 may determine the parameter necessary to perform the determined plurality of actions or a result value output by the execution of the plurality of actions. The parameter and the result value may be defined as a concept of a specified form (or class). As such, the plan may include the plurality of actions and/or a plurality of concepts, which are determined by the intent of the user. The planner module 425 may determine the relationship between the plurality of actions and the plurality of concepts stepwise (or hierarchically). For example, the planner module 425 may determine the execution sequence of the plurality of actions, which are determined based on the user's intent, based on the plurality of concepts. In other words, the planner module 425 may determine an execution sequence of the plurality of actions, based on the parameters necessary to perform the plurality of actions and the result output by the execution of the plurality of actions. Accordingly, the planner module 425 may generate a plan including information (e.g., ontology) about the relationship between the plurality of actions and the plurality of concepts. The planner module 425 may generate the plan, using information stored in the capsule database (DB) 430 storing a set of relationships between concepts and actions.

According to an embodiment, the NLG module 427 may change specified information into information in a text form. The information changed to the text form may be in the form of a natural language speech. The TTS module 429 according to an embodiment may change information in the text form to information in a voice form.

According to an embodiment, all or part of the functions of the natural language platform 420 may be also implemented in the user terminal 301.

The capsule DB 430 may store information about the relationship between the actions and the plurality of concepts corresponding to a plurality of domains. According to an embodiment, the capsule may include a plurality of action objects (or action information) and concept objects (or concept information) included in the plan. According to an embodiment, the capsule DB 430 may store the plurality of capsules in a form of a concept action network (CAN). According to an embodiment, the plurality of capsules may be stored in the function registry included in the capsule DB 430.

The capsule DB 430 may include a strategy registry that stores strategy information necessary to determine a plan corresponding to a voice input. When there are a plurality of plans corresponding to the voice input, the strategy information may include reference information for determining one plan. According to an embodiment, the capsule DB 430 may include a follow-up registry that stores information of the follow-up action for suggesting a follow-up action to the user in a specified context. For example, the follow-up action may include a follow-up utterance. According to an embodiment, the capsule DB 430 may include a layout registry storing layout information of information output via the user terminal 301. According to an embodiment, the capsule DB 430 may include a vocabulary registry storing vocabulary information included in capsule information. According to an embodiment, the capsule DB 430 may include a dialog registry storing information about dialog (or interaction) with the user. The capsule DB 430 may update an object stored via a developer tool. For example, the developer tool may include a function editor for updating an action object or a concept object. The developer tool may include a vocabulary editor for updating a vocabulary. The developer tool may include a strategy editor that generates and registers a strategy for determining the plan. The developer tool may include a dialog editor that creates a dialog with the user. The developer tool may include a follow-up editor capable of activating a follow-up target and editing the follow-up utterance for providing a hint. The follow-up target may be determined based on a target, the user's preference, or an environment condition, which is currently set. The capsule DB 430 according to an embodiment may be also implemented in the user terminal 301.

According to an embodiment, the execution engine 440 may calculate a result by using the generated plan. The end user interface 450 may transmit the calculated result to the user terminal 301. Accordingly, the user terminal 301 may receive the result and may provide the user with the received result. According to an embodiment, the management platform 460 may manage information used by the intelligence server 400. According to an embodiment, the big data platform 470 may collect data of the user. According to an embodiment, the analytic platform 480 may manage quality of service (QoS) of the intelligence server 400. For example, the analytic platform 480 may manage the component and processing speed (or efficiency) of the intelligence server 400.

According to an embodiment, the service server 500 may provide the user terminal 301 with a specified service (e.g., ordering food or booking a hotel). According to an embodiment, the service server 500 may be a server operated by the third party. According to an embodiment, the service server 500 may provide the intelligence server 400 with information for generating a plan corresponding to the received voice input. The provided information may be stored in the capsule DB 430. Furthermore, the service server 500 may provide the intelligence server 400 with result information according to the plan. The service server 500 may include a plurality of service servers 501, 502, 503, . . . .

In the above-described integrated intelligence system, the user terminal 301 may provide the user with various intelligent services in response to a user input. The user input may include, for example, an input through a physical button, a touch input, or a voice input.

According to an embodiment, the user terminal 301 may provide a speech recognition service via an intelligence app (or a speech recognition app) stored therein. In this case, for example, the user terminal 301 may recognize a user utterance or a voice input, which is received via the microphone, and may provide the user with a service corresponding to the recognized voice input.

According to an embodiment, the user terminal 301 may perform a specified action, based on the received voice input, independently, or together with the intelligence server and/or the service server. For example, the user terminal 301 may launch an app corresponding to the received voice input and may perform the specified action via the executed app.

According to an embodiment, when providing a service together with the intelligence server 400 and/or the service server 500, the user terminal 301 may detect a user utterance by using the microphone 370 and may generate a signal (or voice data) corresponding to the detected user utterance. The user terminal may transmit the voice data to the intelligence server 400 by using the communication interface 390.

According to an embodiment, the intelligence server 400 may generate a plan for performing a task corresponding to the voice input or the result of performing an action depending on the plan, as a response to the voice input received from the user terminal 301. For example, the plan may include a plurality of actions for performing the task corresponding to the voice input of the user and/or a plurality of concepts associated with the plurality of actions. The concept may define a parameter to be input upon executing the plurality of actions or a result value output by the execution of the plurality of actions. The plan may include relationship information between the plurality of actions and/or the plurality of concepts.

According to an embodiment, the user terminal 301 may receive the response by using the communication interface 390. The user terminal 301 may output the voice signal generated in the user terminal 301 to the outside by using the speaker 355 or may output an image generated in the user terminal 301 to the outside by using the display 360.

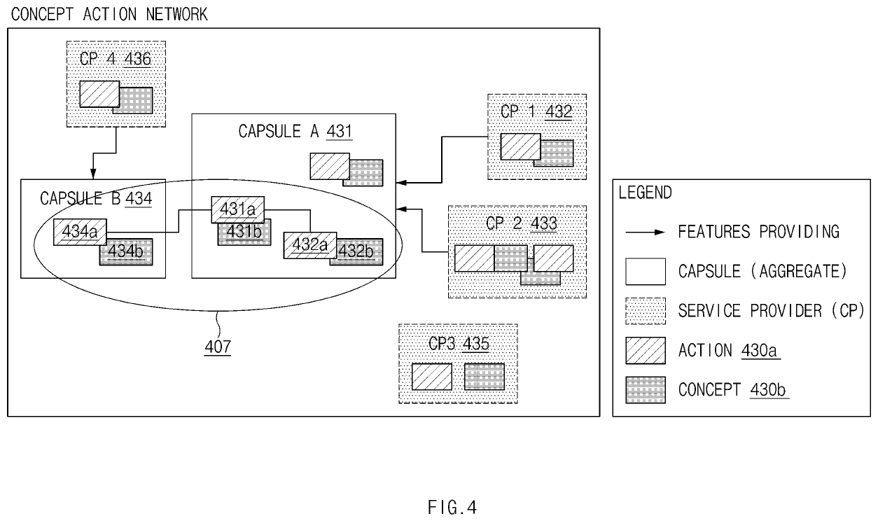

FIG. 4 is a diagram illustrating a form in which relationship information between a concept and an action is stored in a database, according to an embodiment of the disclosure.

A capsule database (e.g., the capsule DB 430) of the intelligence server 400 may store a capsule in the form of a CAN. The capsule DB may store an action for processing a task corresponding to a user's voice input and a parameter necessary for the action, in a form of CAN.

Referring to FIG. 4, the capsule DB may store a plurality capsules (a capsule A 431 and a capsule B 434) respectively corresponding to a plurality of domains (e.g., applications). According to an embodiment, a single capsule (e.g., the capsule A 431) may correspond to a single domain (e.g., a location (geo) or an application). Furthermore, at least one service provider (e.g., CP 1 432, CP 2 433, CP 3 435 or CP 4 436) for performing a function for a domain associated with the capsule may correspond to one capsule. According to an embodiment, the single capsule may include at least one or more actions 430a and at least one or more concepts 430b for performing a specified function.

The natural language platform 420 may generate a plan for performing a task corresponding to the received voice input, using the capsule stored in a capsule database. For example, the planner module 425 of the natural language platform may generate the plan by using the capsule stored in the capsule database. For example, a plan 407 may be generated by using actions 431a and 432a and concepts 431b and 432b of the capsule A 431 and an action 434a and a concept 434b of the capsule B 434.

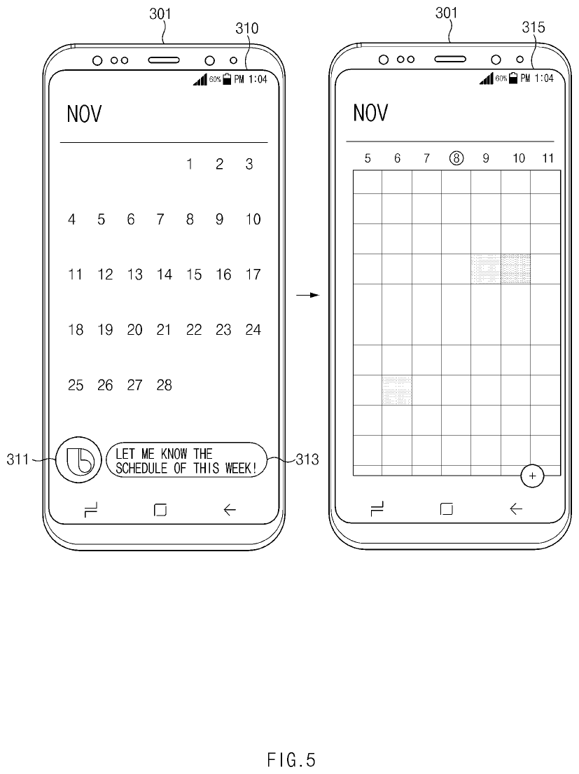

FIG. 5 is a view illustrating a screen in which a user terminal processes a voice input received through an intelligence app, according to an embodiment of the disclosure.

The user terminal 301 may execute an intelligence app to process a user input through the intelligence server 400.

Referring to FIG. 5, on screen 310, when recognizing a specified voice input (e.g., wake up!) or receiving an input via a hardware key (e.g., a dedicated hardware key), the user terminal 301 may launch an intelligence app for processing a voice input. For example, the user terminal 301 may launch the intelligence app in a state where a schedule app is executed. According to an embodiment, the user terminal 301 may display an object (e.g., an icon) 311 corresponding to the intelligence app, on the display 360. According to an embodiment, the user terminal 301 may receive a voice input by a user utterance. For example, the user terminal 301 may receive a voice input saying that “let me know the schedule of this week!” According to an embodiment, the user terminal 301 may display a user interface (UI) 313 (e.g., an input window) of the intelligence app, in which text data of the received voice input is displayed, on a display.

According to an embodiment, on screen 315, the user terminal 301 may display a result corresponding to the received voice input, on the display. For example, the user terminal 301 may receive a plan corresponding to the received user input and may display ‘the schedule of this week’ on the display depending on the plan.

In an embodiment, the user terminal 301 of FIGS. 3, 4, and 5 may correspond to the electronic device 101 of FIG. 1. In an embodiment, the intelligence server 400 of FIG. 3 may correspond to one of the electronic device 104 and the server 108 of FIG. 1. In an embodiment, the processor 320 of FIG. 3 may correspond to the processor 120 of FIG. 1; the display 360 of FIG. 3 may correspond to the display device (i.e., display module 160 of FIG. 1); the speaker 355 of FIG. 3 may correspond to the sound output device (i.e., output module 155 of FIG. 1).

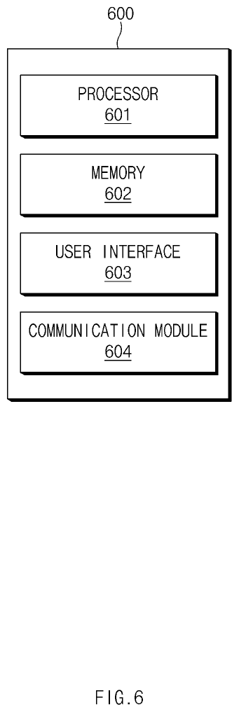

FIG. 6 is a block diagram illustrating a structure of an electronic device 600, according to an embodiment of the disclosure. For clarity of description, details the same as the above-described details may be briefly described or omitted.

Referring to FIG. 6, the electronic device 600 may include a processor 601 (e.g., the processor 320 of FIG. 3 and/or the processor 120 of FIG. 1), a memory 602 (e.g., the memory 130 of FIG. 1), a user interface 603, and a communication module 604 (e.g., the communication module 190 of FIG. 1). The user interface 603 may include a microphone (not illustrated) (e.g., the microphone 370 of FIG. 3 and/or the input module 150 of FIG. 1) and a speaker (not illustrated) (e.g., the speaker 355 of FIG. 3 and/or the sound output device (i.e., output module 155) of FIG. 1).

The electronic device 600 may further include at least one of additional components in addition to the components illustrated in FIG. 6. According to an embodiment, the components of the electronic device 600 may be the same entities or may constitute separate entities.

For example, the electronic device 600 may include a smartphone, a tablet PC, a wearable device, a home appliance, or a digital camera. According to an embodiment, the processor 601 may be operatively coupled to the communication module 604, the memory 602, and the user interface 603 (a microphone (not illustrated) and a speaker (not illustrated)) to perform overall functions of the electronic device 600. For example, the processor 601 may include one or more processors. For example, the one or more processors may include an image signal processor (ISP), an application processor (AP), or a communication processor (CP).

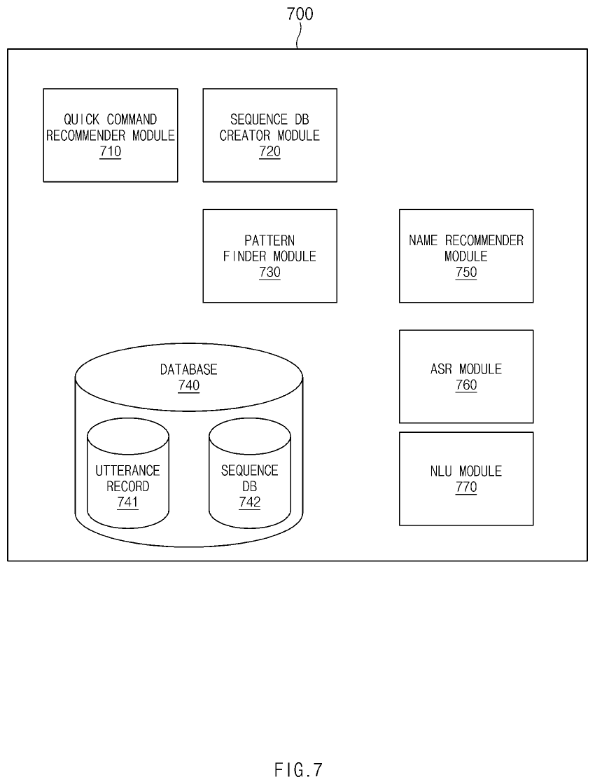

Furthermore, the processor 601 may drive a module (e.g., a quick command recommender module 710, a sequence DB creator module 720, a pattern finder module 730, a name recommender module 750, an ASR module 760, and/or an NLU module 770 in FIG. 7) by executing instructions stored in the memory 602.

The processor 601 may be operatively connected to the module (e.g., the quick command recommender module 710, the sequence DB creator module 720, the pattern finder module 730, the name recommender module 750, the ASR module 760, and/or the NLU module 770 in FIG. 7) to perform overall functions of the electronic device 600. In the embodiment disclosed in this specification, it may be understood that an operation performed (or executed) by the module (e.g., the quick command recommender module 710, the sequence DB creator module 720, the pattern finder module 730, the name recommender module 750, the ASR module 760, and/or the NLU module 770 in FIG. 7) is an operation performed by the processor 601 executing instructions stored in the memory 602.

In an embodiment, the processor 601 may include the module (e.g., the quick command recommender module 710, the sequence DB creator module 720, the pattern finder module 730, the name recommender module 750, the ASR module 760, and/or the NLU module 770 in FIG. 7). In this case, an operation performed (or executed) by each module (e.g., the quick command recommender module 710, the sequence DB creator module 720, the pattern finder module 730, the name recommender module 750, the ASR module 760, and/or the NLU module 770 in FIG. 7) may be implemented as at least part of the processor 601.

Several modules described in various embodiments of the disclosure may be implemented by hardware or software.

The memory 602 may store a database (not illustrated) (e.g., the database 740 of FIG. 7) including at least one input data. The memory 602 may store commands, information, or data associated with operations of components included in the electronic device 600. For example, the memory 602 may store instructions, when executed, that cause the processor 601 to perform various operations described in the disclosure.

In an embodiment, the electronic device 600 may receive a user input by using the user interface 603. The user input may be an input including a user voice signal (e.g., a user's utterance input).

In an embodiment, the user input may be the user's voice input (e.g., an utterance). When the user input is a voice input, the electronic device 600 may receive a user input through a microphone (or a voice receiving device) (not illustrated).

In an embodiment, the user input may be a gesture input and/or a touch input. When the user input is a gesture input and/or a touch input, the electronic device 600 may receive a user input through a sensor (not illustrated).

According to an embodiment, the processor 601 may include a sound module (not illustrated). The sound module may recognize a user input for executing an operation. For example, the sound module may recognize and receive the voice signal. For example, the sound module recognizing the user input may have a high speech recognition rate because ambient noise is strong.

According to an embodiment, the sound module may be learned to recognize and receive the user input by using an algorithm for recognizing a voice. For example, the algorithm for recognizing the voice may be at least one of a hidden Markov model (HMM) algorithm, an artificial neural network (ANN) algorithm, and a dynamic time warping (DTW) algorithm.

According to an embodiment, the sound module may perform tasks of data refinement, data integration, data reduction, and/or data conversion. The data refinement may include an operation of filling in incomplete data and correcting inconsistent data. The data integration may include an operation of merging various divided databases and files for easy analysis. The data reduction may include an operation of sampling only some of input data or reducing the dimension of data to be analyzed. The data conversion may include an operation of normalizing or grouping data by obtaining an average value of the data. The sound module may process data, thereby preventing meaningless values from being included in data or preventing data quality from being degraded due to unintended variables. Accuracy and timeliness may be increased through the sound module.

In an embodiment, at least one operation among operations of each component described with reference to the electronic device 600 may be performed (or executed) by an external server (not illustrated) or another electronic device (not illustrated). For example, the processor 601 may transmit a user input to the external server (not illustrated) or the other electronic device (not illustrated) by using the communication module 604.

A processor (not illustrated) included in an external server (not illustrated) or the other electronic device (not illustrated) may receive the user input, may generate response data, and may transmit the response data to the electronic device 600.

The processor 601 may receive the response data corresponding to the user input from the external server (not illustrated) or the other electronic device (not illustrated) through the communication module 604. When receiving the response data, the processor 601 may allow the output device (i.e., user interface 603) to output the response data. Alternatively, other devices may be controlled through the communication circuit (i.e., communication module 604); alternatively, data may be stored through the communication circuit (i.e., communication module 604). The processor 601 may be composed of at least one or more processors, and may be driven while being physically divided into a main processor performing high-performance processing and an auxiliary processor performing low-power processing. Alternatively, one processor may process data while switching between high performance and low power depending on situations.

Hereinafter, an operation of the processor 601 will be described in detail.

In an embodiment, the processor 601 may extract at least one or more utterance records of a user by using a user account included in the electronic device or operatively connected to the electronic device, may analyze the extracted at least one or more utterance records, may generate an utterance set including at least one or more operations based on the analyzed utterance records, may generate at least one or more quick command names corresponding to the utterance set, and may provide response data including the at least one or more quick command names.

In an embodiment, the processor 601 may receive a voice signal included in a user input by using the sound model operatively connected to the processor and may cause the sound model to be learned by using a learning algorithm.

In an embodiment, the processor 601 may separate at least one or more utterances, which are included in the utterance records, into at least one or more sequences based on at least one of information about a time of an utterance, which is included in the extracted at least one or more utterance records, or information about a location of the utterance.

In an embodiment, the processor 601 may separate at least one or more utterances, which are included in the utterance records, into at least one or more sequences based on information about at least one of a goal, a capsule, or a signal of an utterance included in the extracted at least one or more utterance records.

In an embodiment, the processor 601 may compare utterance reception times of a plurality of utterances included in the extracted at least one or more utterance records and may include the plurality of utterances in an identical sequence when a difference between the utterance reception times is not greater than a specified value.

In an embodiment, the processor 601 may compare the utterance reception times by using the duration information when an utterance including duration information is included in the extracted at least one or more utterance records, and may include the plurality of utterances in the identical sequence when the difference between the utterance reception times, which is obtained by comparing the utterance reception times by using the duration information, is not greater than the specified value.

In an embodiment, the processor 601 may model a relational model between the utterance set and the quick command names and may learn generation or recommendation of the quick command names by using the modeled relational model.

In an embodiment, the processor 601 may perform learning by receiving an utterance included in the utterance set or a natural language (NL) result, which is obtained by analyzing the utterance, as inputs and outputting a quick command name for utterances included in the utterance set as a result by using the relational model.

In an embodiment, the processor 601 may find an important keyword included in the utterance set and may generate the quick command names for the utterance set by using the important keyword.

In an embodiment, the processor 601 may embed a word, a phrase, and an entire utterance included in the utterance set and may generate the quick command names for the utterance set by using at least one of a word and a phrase, which have the highest similarity.

FIG. 7 is another block diagram illustrating a structure of an electronic device 700, according to an embodiment of the disclosure.

For clarity of description, details the same as the above-described details may be briefly described or omitted.

Referring to FIG. 7, the electronic device 700 may include the quick command recommender module 710, the sequence DB creator module 720, the pattern finder module 730, a database 740, the name recommender module 750, the ASR module 760, and/or the NLU module 770. The listed components may be operatively or electrically connected to one another.

The quick command recommender module 710 may analyze the user's utterance record, and may find a repeated sequential utterance set in the user's utterance record. The utterance record of the user may mean a record uttered by the user of the electronic device 700 by using a speech recognition system of the electronic device 700. For example, the utterance record of the user may mean a record of an utterance uttered by the user by using a voice assistant.

In an embodiment, the quick command recommender module 710 may generally manage a function of recording an utterance record 741 in a sequence DB 742, finding a pattern, which appears repeatedly in the sequence DB 742, processing the pattern in a form of a quick command, and recommending a suitable name as a quick command.

FIG. 7 separately illustrates the sequence DB creator module 720, the pattern finder module 730, and the name recommender module 750. However, the quick command recommender module 710 may include the sequence DB creator module 720, the pattern finder module 730, and the name recommender module 750.

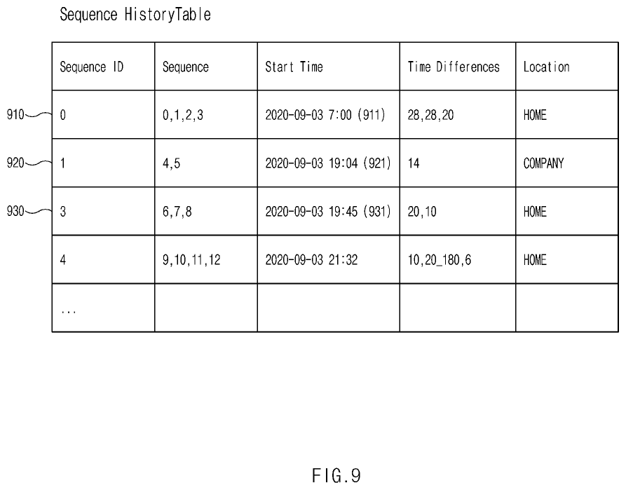

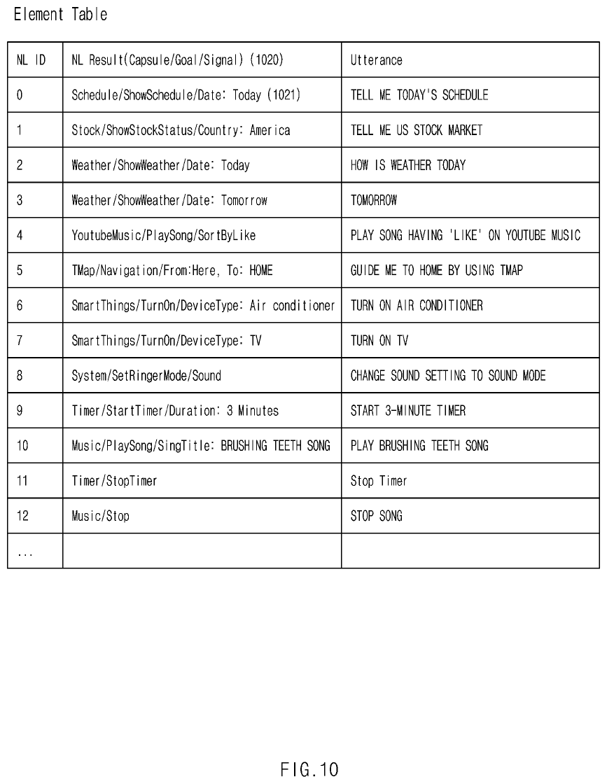

The sequence DB creator module 720 may convert the utterance record 741 of the user into a form of the sequence DB 742 such that the pattern finder module 730 is capable of analyzing a user utterance pattern. The sequence DB creator module 720 may separate the utterance record 741 of the user into at least one or more sequences based on the time and/or location (place) of an utterance. The sequence DB creator module 720 may use the natural language (NL) result (e.g., a capsule, a goal, or a signal) of an utterance as an element capable of being expressed in one sequence. The NL result may mean a result grasped by the NLU module by using text data of the utterance input. For example, the NL result may mean the result of extracting the capsule, goal, and signal of the utterance input. This will be described in detail with reference to FIGS. 9 and 10.

The sequence DB creator module 720 may create one sequence by using whether the user has continuously received utterances. In an embodiment, when a difference in reception time between a plurality of utterances is not greater than a specified threshold with respect to the plurality of utterances received at the same location (place), the sequence DB creator module 720 may include the plurality of utterances received at the same location (place) in one sequence.

In an embodiment, when an utterance including duration information is present in the user's utterance record 741, the sequence DB creator module 720 may compare the utterance with the specified threshold in consideration of the duration information. For example, in the case of a user who frequently employs a 3-minute timer to cook ramen, a pattern indicating that the timer is explicitly terminated after an alarm sounds once may be repeated. In this case, only when the user terminates the alarm while setting the alarm is included in the same sequence, this may be grasped as a pattern. Accordingly, even when the specified threshold is 1 minute, the sequence DB creator module 720 may receive the user's first utterance of “start a 3-minute timer”, and then may receive the user's second utterance of “stop the timer” after 3 minutes and 30 seconds. In this case, the sequence DB creator module 720 may generate one sequence for the first utterance and the second utterance, by using information of ‘3 minutes’, which is duration information included in the first utterance, instead of generating the first utterance and the second utterance as separate sequences by the specified threshold. Even when a long interval is present between the reception times of two utterances thus received, the sequence DB creator module 720 may include two utterances in the same sequence by using the duration information.

The pattern finder module 730 may find a sequential utterance set, which the user frequently and repeatedly employs, by using the sequence DB 742. The pattern finder module 730 may find the utterance set by using a sequential pattern mining algorithm. For example, the pattern finder module 730 may find the desired utterance set by using an algorithm such as GSP, PrefixSpan, and/or SPADE.

In an embodiment, the pattern finder module 730 may calculate the support of a pattern, which is present in the sequence DB 742, by using the sequential pattern mining algorithm. The support may mean the number of sequences, in each of which the pattern is present. For example, when three pieces of sequence data of (Music-Play Song, SmartThings-TurnOn, SmartThings-TurnOn), (Music-PlaySong, SmartThings-TurnOn, Setting-Volume), and (Music-PlaySong, Weather, SmartThings-TurnOn) are present in the sequence DB 742, a pattern of (Music-PlaySong, SmartThings-TurnOn) may be included in all the three sequences, and thus the support may be calculated as 3. A pattern of (Music-PlaySong, Weather) is present in only one sequence, and thus the support is calculated as 1. A pattern of (SmartThings-TurnOn, Music-PlaySong) is not present in a sequence having the corresponding order, and thus the support is calculated as 0.

In an embodiment, the pattern finder module 730 may find patterns, of which the number is not less than the support set by the user in the sequence DB 742, by using a sequential pattern mining algorithm. For example, when three pieces of sequence data of (Music-PlaySong, SmartThings-TurnOn, SmartThings-TurnOn), (Music-PlaySong, SmartThings-TurnOn, Setting-Volume), and (Music-PlaySong, Weather, SmartThings-TurnOn) are present in the sequence DB 742 and the support set by the user is 3, the pattern finder module 730 may find a pattern of (Music-PlaySong, SmartThings-TurnOn).

In an embodiment, when a quick command is generated, the pattern finder module 730 may have a waiting time between utterances by using average reception time information and duration information between elements in a pattern.

The name recommender module 750 may recommend and/or create a quick command name for the found utterance set. In an embodiment, the name recommender module 750 may model the relationship between the quick command name and the utterance set corresponding to the quick command name by using the already-created quick command name and then may recommend a quick command name. For example, the name recommender module 750 may receive, as inputs, an utterance included in the utterance set and/or an NL result of analyzing the utterance and then may output, as a result (output), names of utterances included in the utterance set. The NL result may include a capsule for performing the utterance, a goal for processing the utterance, and a parameter (signal) included in the utterance.

In an embodiment, the electronic device 101 may generate the relational model by using AI. The AI system may be a rule-based system, or may be a neural network-based system (e.g., a feedforward neural network (FNN) and/or a recurrent neural network (RNN)). Alternatively, the AI system may be a combination of the above-described systems or an AI system different from the above-described system.

In an embodiment, the name recommender module 750 may perform learning by using the already-created quick command name and/or the already-created quick command.

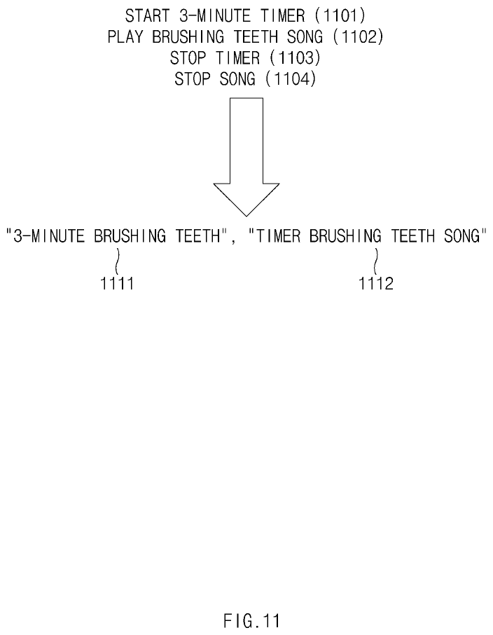

In an embodiment, the name recommender module 750 may find an important keyword of the utterance set, may summarize information about the utterance set, and may recommend and/or generate a quick command name for the utterance set. The important keyword of the utterance set may mean a word or phrase that has a lot of influence on the NL result. For example, the name recommender module 750 may quantify the degree of influence of each of the words on the NL result with respect to words included in the utterance set and may express the qualified degree by using a number. The name recommender module 750 may use words with a high number by using the number expressed in each word and then may combine at least one or more quick command names. This will be described in detail with reference to FIG. 11.

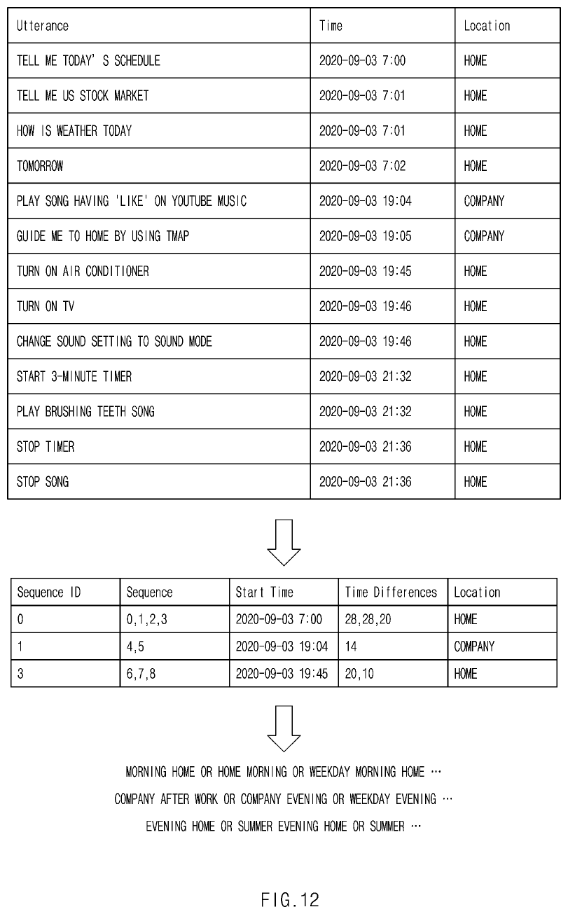

In an embodiment, the name recommender module 750 may generate and/or recommend a quick command name corresponding to the utterance set by using information about an utterance reception time and/or utterance reception location (place) that affected the creation of the utterance set. For example, the name recommender module 750 may consider that each utterance included in the utterance set included in some of the sequences created through the sequence DB creator module 720 has similar utterance reception time information and/or similar utterance reception location (place) information. The name recommender module 750 may generate the quick command name by using the utterance reception time information and/or the utterance reception location information. This will be described in detail with reference to FIG. 12.

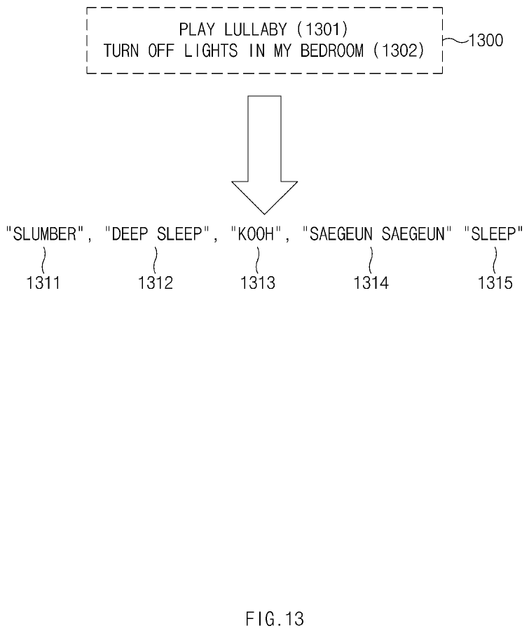

In an embodiment, the name recommender module 750 may find words and/or phrases having a high similarity with words, phrases and/or sentences included in the utterance set and may generate and/or recommend the words and/or phrases as the quick command name. In an embodiment, the name recommender module 750 may embed words, phrases, and/or entire utterances included in the utterance set, may find a word and/or phrase with the highest similarity in a dictionary, and may generate and/or recommend the word and/or phrase as a quick command name. The embedding may refer to a scheme of expressing string data as a numeric vector. For example, the name recommender module 750 may find words and/or phrases with high similarity by using word embedding that expresses words included in the utterance set as a dense vector. This will be described in detail with reference to FIG. 13.

In an embodiment, the name recommender module 750 may recommend the quick command name within a predefined quick command name candidate. For example, the quick command name candidate defined by using user-friendly words and/or phrases such as onomatopoeia, mimetic words and/or magic spells may be stored in the database 740 of the electronic device or a memory (not shown) operatively connected to the electronic device name. The name recommender module 750 may recommend a quick command name by using the defined quick command name candidate.

In an embodiment, even when the user directly creates the quick command, the name recommender module 750 may generate and/or recommend a quick command name. For example, the name recommender module 750 may determine whether there is an utterance having the same NL result (e.g. a capsule, a goal, or a signal) as the quick command generated by the user and may recommend the quick command name by using the location and time information of the utterance record including the corresponding utterance.

The ASR module 760 may convert the received user input into text data. For example, the ASR module 760 may convert the received voice data into text data.

The NLU module 770 may grasp the user's intent by performing syntactic analysis or semantic analysis. According to an embodiment, the NLU module 770 may grasp the meaning of words extracted from the voice input by using linguistic features (e.g., syntactic elements) such as morphemes or phrases and may determine the intent of the user by matching the grasped meaning of the words to the intent.

According to an embodiment disclosed in this specification, a user-customized quick command name may be created and/or recommended by creating and/or recommending a quick command name by using the user's utterance record.

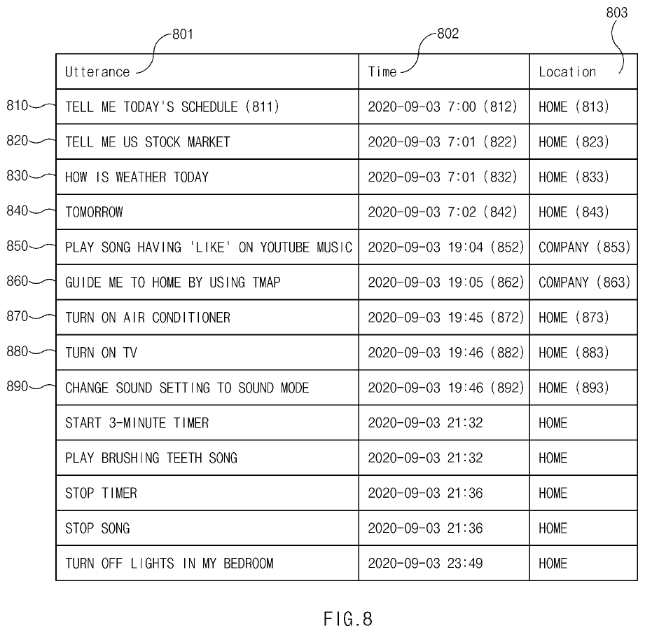

FIG. 8 is a diagram of a user's utterance record, according to an embodiment of the disclosure.

For clarity of description, details the same as the above-described details may be briefly described or omitted. The utterance record of the user may mean a record uttered by the user of the electronic device 700 by using the speech recognition system of the electronic device 700. For example, the utterance record of the user may mean a record of an utterance uttered by the user by using a voice assistant. The electronic device 700 may store the user's utterance record in the utterance record 741 of FIG. 7.

Referring to FIG. 8, the utterance record of the user may include information about utterance content (utterance) 801, an utterance time (time) 802, and an utterance place (location) 803 of a user utterance.

For example, a first utterance 810 of a user may include information about utterance content 811 of ‘tell me today's schedule’, an utterance time 812 of ‘Sep. 3, 2020 7:00 AM’, and an utterance place (location) 813 of ‘home’.

The first utterance 810, a second utterance 820, a third utterance 830, and a fourth utterance 840 in FIG. 8 may include information about the same utterance places (locations) 813, 823, 833, and 843 of ‘home’ and information about similar utterance times 812, 822, 832, and 842 from ‘Sep. 3, 2020 7:00 AM’ to ‘Sep. 3, 2020 7:02 AM’.

A fifth utterance 850 and a sixth utterance 860 of FIG. 8 may include information about the same utterance places (locations) 853 and 863 of ‘company’ and information about similar utterance times 852 and 862 on ‘Sep. 3, 2020 19:04’ and ‘Sep. 3, 2020 19:05’.

A seventh utterance 870, an eighth utterance 880, and a ninth utterance 890 in FIG. 8 may include information about the same utterance places (locations) 873, 883, and 893 of ‘home’ and information about similar utterance times 872, 882, and 892 from ‘Sep. 3, 2020 19:45’ to ‘Sep. 3, 2020 19:46’.

The electronic device 700 may convert the utterance record of FIG. 8 into a form of a sequence DB by using the similarity of information included in the utterance record. For example, a sequence DB creator module (e.g., the sequence DB creator module 720 of FIG. 7) may convert the user's utterance record into a form of a sequence DB (e.g., the sequence DB 742 of FIG. 7) such that the pattern finder module (e.g., the pattern finder module 730 of FIG. 7) is capable of analyzing a user utterance pattern.

FIG. 9 is a diagram in which a conversation record of a user is converted into a sequence, according to an embodiment of the disclosure.

For clarity of description, details the same as the above-described details may be briefly described or omitted.

The sequence of FIG. 9 is a diagram in which the utterance record of the user shown in FIG. 8 is divided into at least one sequence based on information about a time and/or location (place) of an utterance. This is described together with reference to FIG. 8.

Referring to FIG. 9, the first sequence 910 of FIG. 9 is obtained as the electronic device 700 expresses the first utterance 810, the second utterance 820, the third utterance 830, and the fourth utterance 840 of FIG. 8 as one sequence. The first utterance 810, the second utterance 820, the third utterance 830, and the fourth utterance 840 in FIG. 8 may include information about the same utterance places (locations) 813, 823, 833, and 843 of ‘home’ and information about similar utterance times 812, 822, 832, and 842 from ‘Sep. 3, 2020 7:00 AM’ to ‘Sep. 3, 2020 7:02 AM’.

Accordingly, the electronic device 700 may express the first utterance 810, the second utterance 820, the third utterance 830, and the fourth utterance 840 in FIG. 8 as one sequence. The electronic device 700 may express the utterance time 812 of the first utterance, which is a start utterance of the first sequence 910, as a start time 911 of the first sequence.

A second sequence 920 of FIG. 9 is obtained as the electronic device 700 expresses the fifth utterance 850 and the sixth utterance 860 of FIG. 8 as one sequence. The fifth utterance 850 and the sixth utterance 860 of FIG. 8 may include information about the same utterance places (locations) 853 and 863 of ‘company’ and information about similar utterance times 852 and 862 on ‘Sep. 3, 2020 19:04’ and ‘Sep. 3, 2020 19:05’. Accordingly, the electronic device 700 may express the fifth utterance 850 and the sixth utterance 860 in FIG. 8 as one sequence. The electronic device 700 may express the utterance time 852 of the fifth utterance, which is a start utterance of the second sequence 920, as a start time 921 of the second sequence.

A third sequence 930 of FIG. 9 is obtained as the electronic device 700 expresses the seventh utterance 870, the eighth utterance 880, and the ninth utterance 890 of FIG. 8 as one sequence. The seventh utterance 870, the eighth utterance 880, and the ninth utterance 890 in FIG. 8 may include information about the same utterance places (locations) 873, 883, and 893 of ‘home’ and information about similar utterance times 872, 882, and 892 from ‘Sep. 3, 2020 19:45’ to ‘Sep. 3, 2020 19:46’. Accordingly, the electronic device 700 may express the seventh utterance 870, the eighth utterance 880, and the ninth utterance 890 in FIG. 8 as one sequence. The electronic device 700 may express the utterance time 872 of the seventh utterance, which is a start utterance of the third sequence 930, as a start time 931 of the third sequence.

FIG. 10 is a diagram of an element table including an NL result of an utterance generated by analyzing a user's utterance record, according to an embodiment of the disclosure.

The element table of FIG. 10 is a diagram of an element table including an NL result of an utterance generated by analyzing an utterance record of a user shown in FIG. 8. This will be described together with reference to FIG. 8. For clarity of description, details the same as the above-described details may be briefly described or omitted.

The electronic device 700 may analyze an utterance content (utterance) (e.g., the utterance content 801 in FIG. 8) of the user's utterance record and then may generate an NL result 1020 of an utterance including information about a capsule for performing the utterance, a goal for processing the utterance, and a parameter (signal) included in the utterance.

For example, the electronic device 700 may analyze the meaning of ‘tell me today's schedule’, which is the utterance content (utterance) of the first utterance 810 of FIG. 8 and then may generate a first NL result 1021 depending on the analyzed meaning. Referring to FIG. 10, the first NL result 1021 includes (schedule, show schedule, date: today) as a result for a capsule for performing the utterance, a goal for processing the utterance, and a parameter (signal) included in the utterance, respectively.

When the user directly creates a quick command, the electronic device 700 may determine whether there is an utterance having the same NL result (e.g., an NL result the same as at least one or more of a capsule for performing an utterance, a goal for processing the utterance, and a parameters (signal) included in the utterance) as the quick command created by the user, by using the element table of FIG. 10.

FIGS. 11 to 13 are conceptual diagrams of a method, in which the electronic device 700 recommends a quick command name, according to an embodiment of the disclosure.

FIG. 11 is a conceptual diagram of a method, in which the electronic device 700 recommends a quick command name by using an important keyword, according to an embodiment of the disclosure.

The electronic device 700 may find an important keyword of the utterance set, may summarize information about the utterance set, and may recommend and/or generate a quick command name for the utterance set. The important keyword of the utterance set may mean a word or phrase that has a lot of influence on the NL result. For example, the electronic device 700 may find a word or phrase that has a lot of influence on the NL result and then may generate a quick command name by using the corresponding word or phrase.

Referring to FIG. 11, in a case of utterances 1101, 1102, 1103, and 1104, words such as “3 minutes”, “timer”, “brushing teeth song”, and “song” may have a lot of influence on classifying a capsule for performing the actual utterance of each utterance, a goal for processing the utterance, and a parameter (signal) included in the utterance. Accordingly, a quick command name such as “3-minute brushing” 1111 and “timer brushing teeth song” 1112 may be created based on these words or phrases.

FIG. 12 is a conceptual diagram illustrating a method, in which the electronic device 700 recommends a quick command name by using information about utterance reception time and/or utterance reception place, according to an embodiment of the disclosure.

Referring to FIG. 12, the electronic device 700 may generate and/or recommend a quick command name corresponding to the utterance set by using information about an utterance reception time and/or utterance reception location (place) that affected the creation of the utterance set. The conceptual diagram shown in FIG. 12 is the same as the description given with reference to FIGS. 8 to 11, and thus are omitted to avoid redundancy.

FIG. 13 is a conceptual diagram illustrating a method, in which the electronic device 700 finds words and/or phrases having a high similarity with words, phrases and/or sentences included in an utterance set and generates and/or recommends the words and/or phrases as the quick command name, according to an embodiment of the disclosure.

The electronic device 700 may embed words, phrases, and/or entire utterances included in the utterance set, may find a word and/or phrase with the highest similarity in a dictionary, and may generate and/or recommend the word and/or phrase as a quick command name. The embedding may refer to a scheme of expressing string data as a numeric vector. For example, the name recommender module 750 may find words and/or phrases with high similarity by using word embedding that expresses a word included in the utterance set as a dense vector.

Referring to FIG. 13, for an instruction set as an example, when a first utterance 1301 and a second utterance 1302 included in a first utterance set 1300 are embedded, each of the embedded utterances may have a high similarity value, which uses a similarity scale such as euclidean distance or cosine similarity, with the embedding of words such as “slumber”, “deep sleep”, and “sleep”. The electronic device 700 may recommend a quick command name of “slumber” 1311, “deep sleep” 1312, “kooh” (onomatopoeia) 1313, “saegeun saegeun” (onomatopoeia) 1314, and/or “sleep” 1315 for the first utterance set 1300.

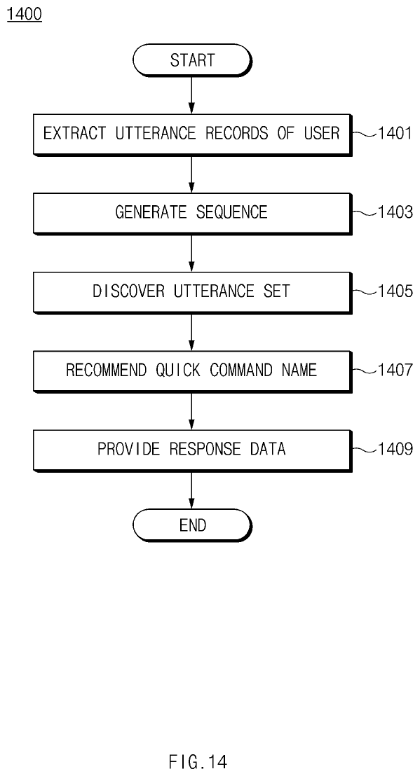

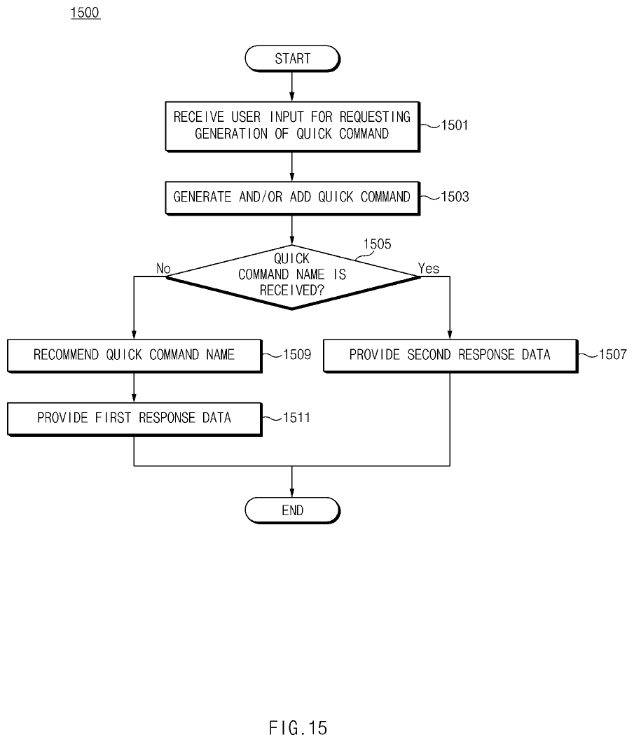

Hereinafter, a method performed by the electronic device 101 according to an embodiment disclosed in the specification will be described with reference to FIGS. 14 and 15.

FIG. 14 is a flowchart of a method, in which an electronic device recommends a quick command name, according to an embodiment of the disclosure.

According to an embodiment, it may be understood that the process illustrated in FIG. 14 is performed by the processor (e.g., the processor 120 of FIG. 1) of an electronic device (e.g., the electronic device 101 of FIG. 1) by executing instructions stored in a memory (e.g., the memory 130 of FIG. 1).

Referring to FIG. 14, in a method 1400, in operation 1401, the electronic device 101 may extract at least one or more utterance records of a user. The utterance record of the user may mean a record uttered by the user of the electronic device 101 by using a speech recognition system of the electronic device 101. For example, the utterance record of the user may mean a record of an utterance uttered by the user by using a voice assistant. The user's utterance record may mean data stored in the storage included in the electronic device 101 or operatively connected to the electronic device 101. The electronic device 101 may extract at least one or more conversation records of a user by using a user account included in the electronic device 101 or operatively connected to the electronic device 101.

In an embodiment, the electronic device 101 may extract the utterance record of the user in response to a user input. The user input may include a touch input, a gesture input, and/or a voice input. In an embodiment, the electronic device 101 may receive the user input by using a user interface.

In an embodiment, the user input may be the user's voice input (e.g., an utterance). When the user input is a voice input, the electronic device 101 may receive the user input through a microphone (or a voice receiving device) included in the electronic device or operatively connected to the electronic device.

In an embodiment, the user input may be a gesture input and/or a touch input. When the user input is a gesture input and/or a touch input, the electronic device 101 may receive the user input through a sensor included in the electronic device or operatively connected to the electronic device.

In an embodiment, the electronic device 101 may identify input data matched with the received user input. For example, when the user input is a voice input (e.g., an utterance), the electronic device 101 may convert the received user input into text data. In an embodiment, the electronic device 101 may process data of the received voice input of the user. For example, the electronic device 101 may perform data refinement, data integration, data reduction, and/or data conversion on the received voice input data of the user. The electronic device 101 may improve the quality of data by processing the data.

In operation 1403, the electronic device 101 may analyze the user's utterance record and may convert the utterance record into a sequence form.

In an embodiment, the electronic device 101 may separate the utterance record of the user into at least one or more sequences based on the time and/or location (place) of an utterance. The electronic device 101 may use the NL result (e.g., a capsule, a goal, or a signal) of an utterance as an element capable of being expressed in one sequence.

The electronic device 101 may create one sequence by using whether the user has continuously received utterances. In an embodiment, when a difference in reception time between a plurality of utterances is not greater than a specified threshold with respect to the plurality of utterances received at the same location (place), the electronic device 101 may include the plurality of utterances received at the same location (place) in one sequence.

In an embodiment, when an utterance including duration information is present in the user's utterance record, the electronic device 101 may compare the utterance with the specified threshold in consideration of the duration information. For example, in the case of a user who frequently employs a 3-minute timer to cook ramen, a pattern indicating that the timer is explicitly terminated after an alarm sounds once may be repeated. In this case, only when the user terminates the alarm while setting the alarm is included in the same sequence, this may be grasped as a pattern. Accordingly, even when the specified threshold is 1 minute, the electronic device 101 may receive the user's first utterance of “start a 3-minute timer”, and then may receive the user's second utterance of “stop the timer” after 3 minutes and 30 seconds. In this case, the electronic device 101 may generate one sequence for the first utterance and the second utterance, by using information of ‘3 minutes’, which is duration information included in the first utterance, instead of generating the first utterance and the second utterance as separate sequences by the specified threshold. Even when a long interval is present between the reception times of two utterances thus received, the electronic device 101 may include two utterances in the same sequence by using the duration information.

In operation 1405, the electronic device 101 may discover an utterance set. The electronic device 101 may find a sequential utterance set, which the user frequently and repeatedly employs, by using the sequence. The electronic device 101 may find the utterance set by using a sequential pattern mining algorithm. For example, the electronic device 101 may find the desired utterance set by using an algorithm such as GSP, PrefixSpan, and/or SPADE.

In an embodiment, the electronic device 101 may calculate the support of a pattern that is present in a database (e.g., the sequence DB 742 of FIG. 7) included in the electronic device 101 or operatively connected to the electronic device 101. The support may mean the number of sequences, in each of which the pattern is present. For example, when three pieces of sequence data of (Music-PlaySong, SmartThings-TurnOn, SmartThings-TurnOn), (Music-Play Song, SmartThings-TurnOn, Setting-Volume), and (Music-PlaySong, Weather, SmartThings-TurnOn) are present in a database (e.g., the sequence DB 742 of FIG. 7) included in the electronic device 101 or operatively connected to the electronic device 101, a pattern of (Music-PlaySong, SmartThings-TurnOn) may be included in all the three sequences, and thus the support may be calculated as 3. A pattern of (Music-PlaySong, Weather) is present in only one sequence, and thus the support is calculated as 1. A pattern of (SmartThings-TurnOn, Music-PlaySong) is not present in a sequence having the corresponding order, and thus the support is calculated as 0.

In an embodiment, the electronic device 101 may find patterns, of which the number is not less than the support set by the user, in a database (e.g., the sequence DB 742 of FIG. 7) included in the electronic device 101 or operatively connected to the electronic device 101. For example, when three pieces of sequence data of (Music-Play Song, SmartThings-TurnOn, SmartThings-TurnOn), (Music-PlaySong, SmartThings-TurnOn, Setting-Volume), and (Music-PlaySong, Weather, SmartThings-TurnOn) are present in a database (e.g., the sequence DB 742 of FIG. 7), which is included in the electronic device 101 or which is operatively connected to the electronic device 101, and the support set by the user is 3, the electronic device 101 may find a pattern of (Music-PlaySong, SmartThings-TurnOn).

In an embodiment, when a quick command is generated, the electronic device 101 may have a waiting time between utterances by using average reception time information and duration information between elements in a pattern.

In operation 1407, the electronic device 101 may recommend and/or generate a quick command name. In an embodiment, the electronic device 101 may model the relationship between the quick command name and the utterance set corresponding to the quick command name by using the already-created quick command name and then may recommend a quick command name. For example, the electronic device 101 may receive, as inputs, an utterance included in the utterance set and/or an NL result of analyzing the utterance and then may output, as a result (output), names of utterances included in the utterance set. The NL result may include a capsule for performing the utterance, a goal for processing the utterance, and a parameter (signal) included in the utterance.

In an embodiment, the electronic device 101 may generate the relational model by using AI. The AI system may be a rule-based system, or may be a neural network-based system (e.g., a feedforward neural network (FNN) and/or a recurrent neural network (RNN)). Alternatively, the AI system may be a combination of the above-described systems or an AI system different from the above-described system.

In an embodiment, the electronic device 101 may perform learning by using the already-created quick command name and/or the already-created quick command.

In an embodiment, the electronic device 101 may find an important keyword of the utterance set, may summarize information about the utterance set, and may recommend and/or generate a quick command name for the utterance set. The important keyword of the utterance set may mean a word or phrase that has a lot of influence on the NL result. For example, the electronic device 101 may quantify the degree of influence of each of the words on the NL result with respect to words included in the utterance set and may express the qualified degree by using a number. The electronic device 101 may use words with a high number by using the number expressed in each word and then may combine at least one or more quick command names.

In an embodiment, the electronic device 101 may generate and/or recommend a quick command name corresponding to the utterance set by using information about an utterance reception time and/or utterance reception location (place) that affected the creation of the utterance set. For example, the electronic device 101 may consider that each utterance included in the utterance set included in some of sequences stored in a database (e.g., the sequence DB 742 of FIG. 7), which is included in the electronic device 101 or which is operatively connected to the electronic device 101, has similar utterance reception time information and/or similar utterance reception location (place) information. The electronic device 101 may generate the quick command name by using the utterance reception time information and/or the utterance reception location information.

In an embodiment, the electronic device 101 may find words and/or phrases having a high similarity with words, phrases and/or sentences included in the utterance set and may generate and/or recommend the words and/or phrases as the quick command name. In an embodiment, the electronic device 101 may embed words, phrases, and/or entire utterances included in the utterance set, may find a word and/or phrase with the highest similarity in a dictionary, and may generate and/or recommend the word and/or phrase as a quick command name. The embedding may refer to a scheme of expressing string data as a numeric vector. For example, the electronic device 101 may find words and/or phrases with high similarity by using word embedding that expresses words included in the utterance set as a dense vector.

In an embodiment, the electronic device 101 may recommend the quick command name within a predefined quick command name candidate. For example, the quick command name candidate defined by using user-friendly words and/or phrases such as onomatopoeia, mimetic words and/or magic spells may be stored in a database of the electronic device or a memory (not shown) operatively connected to the electronic device name. The electronic device 101 may recommend a quick command name by using the defined quick command name candidate.

In an embodiment, even when the user directly creates the quick command, the electronic device 101 may generate and/or recommend a quick command name. For example, the electronic device 101 may determine whether there is an utterance having the same NL result (e.g. a capsule, a goal, or a signal) as the quick command generated by the user and may recommend the quick command name by using the location and time information of the utterance record including the corresponding utterance.

In operation 1409, the electronic device 101 may provide response data. The response data may mean data including at least one or more quick command names. The electronic device 101 may provide a user with the response data including the at least one or more quick command names by using an output device (e.g., a display or a speaker) included in the electronic device 101 or operatively connected to the electronic device 101.

In an embodiment, the electronic device 101 may convert response data including the quick command name in a form of a text into voice data by using a TTS module. The electronic device 101 (and/or a processor (not shown)) may output response data converted into voice data through a speaker (not shown).

It is illustrated in FIG. 14 that the electronic device 101 sequentially performs operation 1401 to operation 1409. However, this is only an example. For example, the operations may be performed at the same time. A part of the operations may be performed by the electronic device 101 and the other parts may be performed by an external device. For example, operation 1409 may be performed by the electronic device 101 and operation 1401 to operation 1407 may be performed by a server.

FIG. 15 is another flowchart of a method, in which an electronic device recommends a quick command name, according to an embodiment of the disclosure.

According to an embodiment, it may be understood that the process illustrated in FIG. 15 is performed by the processor (e.g., the processor 120 of FIG. 1) of an electronic device (e.g., the electronic device 101 of FIG. 1) by executing instructions stored in a memory (e.g., the memory 130 of FIG. 1).

Referring to FIG. 15, in a method 1500, in operation 1501, the electronic device 101 may receive a user input for requesting generation of a quick command. The user input may include a touch input, a gesture input, and/or a voice input. In an embodiment, the electronic device 101 may receive the user input by using a user interface.

In an embodiment, the user input may be the user's voice input (e.g., an utterance). When the user input is a voice input, the electronic device 101 may receive the user input through a microphone (or a voice receiving device) included in the electronic device or operatively connected to the electronic device.

In an embodiment, the user input may be a gesture input and/or a touch input. When the user input is a gesture input and/or a touch input, the electronic device 101 may receive the user input through a sensor included in the electronic device or operatively connected to the electronic device.

In operation 1503, the electronic device 101 may generate and/or add a quick command in response to the received user input.

In an embodiment, the electronic device 101 may identify input data matched with the received user input. For example, when the user input is a voice input (e.g., an utterance), the electronic device 101 may convert the received user input into text data. The electronic device 101 may generate at least one or more quick commands included in the user input by identifying the converted text and may add the generated quick commands as an utterance record to a database included in the electronic device 101 or operationally connected to the electronic device 101.

In operation 1505, the electronic device 101 may determine whether the quick command name is received. When determining that the quick command name has been received, the electronic device 101 may perform operation 1507.

In operation 1507, the electronic device 101 may provide second response data. The second response data may mean data including the received quick command name and/or the received quick command.

In an embodiment, the electronic device 101 may store the received quick command and the received quick command name in a database included in the electronic device 101 or operatively connected to the electronic device 101.

In an embodiment, the electronic device 101 may analyze the received quick command and the received quick command name and then may recommend at least one or more quick commands capable of being included in one utterance set. The electronic device 101 may include the at least one or more quick commands in the second response data and then may provide the second response data.

On the other hand, when determining that the quick command name has not been received in operation 1505, the electronic device 101 may perform operation 1509.

In operation 1509, the electronic device 101 may recommend a quick command name. The electronic device 101 may generate and/or recommend the quick command name by using the user's utterance record and a sequence, which are stored in a database included in the electronic device 101 or operatively connected to the electronic device 101. This is described in detail with reference to FIG. 14, and thus is omitted to avoid redundancy.

In operation 1511, the electronic device 101 may provide first response data. The first response data may mean data including at least one or more quick command names. The electronic device 101 may provide a user with the response data including the at least one or more quick command names by using an output device (e.g., a display or a speaker) included in the electronic device 101 or operatively connected to the electronic device 101.

It is illustrated in FIG. 15 that the electronic device 101 sequentially performs operation 1501 to operation 1511. However, this is only an example. For example, the operations may be performed at the same time. A part of the operations may be performed by the electronic device 101 and the other parts may be performed by an external device. For example, operation 1501, operation 1507, and operation 1511 may be performed by the electronic device 101, and operation 1503, operation 1505, and operation 1509 may be performed by a server.

In an embodiment, a method performed by the electronic device 101 may include extracting at least one or more utterance records of a user by using a user account included in the electronic device or operatively connected to the electronic device when a process for a memory included in the electronic device or operatively connected to the electronic device is executed, analyzing the extracted at least one or more utterance records, generating an utterance set including at least one or more operations based on the analyzed utterance records, generating at least one or more quick command names corresponding to the utterance set, and providing response data including the at least one or more quick command names.

In an embodiment, the method performed by the electronic device 101 may further include receiving a voice signal included in a user input by using a sound model included in the electronic device or operatively connected to the electronic device and causing the sound model to be learned by using a learning algorithm.

In an embodiment, the method performed by the electronic device 101 may further include separating at least one or more utterances, which are included in the utterance records, into at least one or more sequences based on at least one of information about a time of an utterance, which is included in the extracted at least one or more utterance records, or information about a location of the utterance.

In an embodiment, the method performed by the electronic device 101 may further include separating at least one or more utterances, which are included in the utterance records, into at least one or more sequences based on information about at least one of a goal, a capsule, or a signal of an utterance included in the extracted at least one or more utterance records.

In an embodiment, the method performed by the electronic device 101 may further include comparing utterance reception times of a plurality of utterances included in the extracted at least one or more utterance records and including the plurality of utterances in an identical sequence when a difference between the utterance reception times is not greater than a specified value.

In an embodiment, the method performed by the electronic device 101 may further include comparing the utterance reception times by using the duration information when an utterance including duration information is included in the extracted at least one or more utterance records, and including the plurality of utterances in the identical sequence when the difference between the utterance reception times, which is obtained by comparing the utterance reception times by using the duration information, is not greater than the specified value.

In an embodiment, the method performed by the electronic device 101 may further include modeling a relational model between the utterance set and the quick command names and learning generation or recommendation of the quick command names by using the modeled relational model.

In an embodiment, the method performed by the electronic device 101 may further include performing learning by receiving an utterance included in the utterance set or an NL result, which is obtained by analyzing the utterance, as inputs and outputting a quick command name for utterances included in the utterance set as a result by using the relational model.

In an embodiment, the method performed by the electronic device 101 may further include finding an important keyword included in the utterance set and generating the quick command names for the utterance set by using the important keyword.

In an embodiment, the method performed by the electronic device 101 may further include embedding a word, a phrase, and an entire utterance included in the utterance set and generating the quick command names for the utterance set by using at least one of a word and a phrase, which have the highest similarity.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a processor; and
a memory operatively connected to the processor,
wherein the memory stores instructions that, when executed, cause the processor to:
extract at least one or more utterance records of a user by using a user account included in the electronic device or operatively connected to the electronic device,
analyze the extracted at least one or more utterance records,
generate an utterance set comprising at least one or more operations based on the analyzed utterance records,
generate at least one or more quick command names corresponding to the utterance set, and
provide response data comprising the at least one or more quick command names.

2. The electronic device of claim 1,
wherein a sound model operatively connected to the processor, and
wherein the instructions cause the processor to:
receive a voice signal included in a user input by using the sound model, and
cause the sound model to be learned by using a learning algorithm.

3. The electronic device of claim 1, wherein the instructions further cause the processor to:
separate at least one or more utterances, which are included in the utterance records, into at least one or more sequences based on at least one of information about a time of an utterance, which is included in the extracted at least one or more utterance records, or information about a location of the utterance.

4. The electronic device of claim 1, wherein the instructions further cause the processor to:
separate at least one or more utterances, which are included in the utterance records, into at least one or more sequences based on information about at least one of a goal, a capsule, or a signal of an utterance included in the extracted at least one or more utterance records.

5. The electronic device of claim 1, wherein the instructions further cause the processor to:
compare utterance reception times of a plurality of utterances included in the extracted at least one or more utterance records, and
when a difference between the utterance reception times is not greater than a specified value, include the plurality of utterances in an identical sequence.

6. The electronic device of claim 5, wherein the instructions further cause the processor to:
when an utterance comprising duration information is included in the extracted at least one or more utterance records, compare the utterance reception times by using the duration information, and
when the difference between the utterance reception times, which is obtained by comparing the utterance reception times by using the duration information, is not greater than the specified value, include the plurality of utterances in the identical sequence.

7. The electronic device of claim 1, wherein the instructions further cause the processor to:
model a relational model between the utterance set and the quick command names, and
learn generation or recommendation of the quick command names by using the modeled relational model.

8. The electronic device of claim 7, wherein the instructions further cause the processor to:
perform learning by receiving an utterance included in the utterance set or a natural language (NL) result, which is obtained by analyzing the utterance, as inputs and outputting a quick command name for utterances included in the utterance set as a result by using the relational model.

9. The electronic device of claim 1, wherein the instructions further cause the processor to:
find an important keyword included in the utterance set, and
generate the quick command names for the utterance set by using the important keyword.

10. The electronic device of claim 1, wherein the instructions further cause the processor to:
embed a word, a phrase, and an entire utterance included in the utterance set and generate the quick command names for the utterance set by using at least one of a word and a phrase, which have the highest similarity.

11. A method performed by an electronic device, the method comprising:
when a process for a memory included in the electronic device or operatively connected to the electronic device is executed, extracting at least one or more utterance records of a user by using a user account included in the electronic device or operatively connected to the electronic device;
analyzing the extracted at least one or more utterance records;
generating an utterance set comprising at least one or more operations based on the analyzed utterance records;
generating at least one or more quick command names corresponding to the utterance set; and
providing response data comprising the at least one or more quick command names.

12. The method of claim 11, further comprising:
receiving a voice signal included in a user input by using a sound model included in the electronic device or operatively connected to the electronic device; and
causing the sound model to be learned by using a learning algorithm.

13. The method of claim 11, further comprising:
separating at least one or more utterances, which are included in the utterance records, into at least one or more sequences based on at least one of information about a time of an utterance, which is included in the extracted at least one or more utterance records, or information about a location of the utterance.

14. The method of claim 11, further comprising:
separating at least one or more utterances, which are included in the utterance records, into at least one or more sequences based on information about at least one of a goal, a capsule, or a signal of an utterance included in the extracted at least one or more utterance records.

15. The method of claim 11, further comprising:
comparing utterance reception times of a plurality of utterances included in the extracted at least one or more utterance records; and
when a difference between the utterance reception times is not greater than a specified value, including the plurality of utterances in an identical sequence.

16. The method of claim 15, further comprising:
when an utterance including duration information is included in the extracted at least one or more utterance records, comparing the utterance reception times by using the duration information; and
when the difference between the utterance reception times, which is obtained by comparing the utterance reception times by using the duration information, is not greater than the specified value, including the plurality of utterances in the identical sequence.

17. The method of claim 11, further comprising:
modeling a relational model between the utterance set and the quick command names; and
learning generation or recommendation of the quick command names by using the modeled relational model.

18. The method of claim 17, further comprising:
performing learning by receiving an utterance included in the utterance set or a natural language (NL) result, which is obtained by analyzing the utterance, as inputs and outputting a quick command name for utterances included in the utterance set as a result by using the relational model.

19. The method of claim 11, further comprising:
finding an important keyword included in the utterance set; and
generating the quick command names for the utterance set by using the important keyword.

20. The method of claim 11, further comprising:
embedding a word, a phrase, and an entire utterance included in the utterance set and generating the quick command names for the utterance set by using at least one of a word and a phrase, which have the highest similarity.
